(19) United States
(12) Patent Application Publication
(10) Pub. No.: US 2004/0061431 A1
(43) Pub. Date: Apr. 1, 2004

(54) Light emission device and field emission display having such light emission devices

(75) Inventors: Yukihisa Takeuchi, Nishikamo-Gun (JP); Tsutomu Nanataki, Toyoake-City (JP); Iwao Ohwada, Nagoya-City (JP); Nobuyuki Kokune, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/671,763

(22) Filed: Sep. 26, 2003

(30) Foreign Application Priority Data
Sep. 30, 2002 (JP) 2002-286207
Aug. 25, 2003 (JP) 2003-299576

(51) Int. Cl. H01J 1/62

(52) U.S. Cl. 313/495

(57) ABSTRACT

When a pulsed voltage is applied to a drive electrode, an electric field is concentrated in the vicinity of a slit, producing a field emission phenomenon. The emitted electrons are applied to a fluorescent layer when a bias voltage is applied preferably to a common electrode or a collector electrode. The fluorescent layer is excited to emit light as indicated by the arrows. Light emission devices may be arranged in a two-dimensional array, providing a field emission display.

This application claims the benefit of Japanese Application 2002-286207, filed Sep. 30, 2002, and Japanese Application 2003-299576, filed Aug. 25, 2003, the entireties of which are incorporated herein by reference.

### BACKGROUND OF THE INVENTION

1. Field of the Invention

The present invention relates to a light emission device and a field emission display having such light emission devices.

2. Description of the Related Art

In recent years, various applications such as field emission displays (FED) and back lights employ electron emitters having drive electrodes and ground electrodes (see, for example, Japanese laid-open patent publication No. 1-311533; Japanese laid-open patent publication No. 7-147131; Japanese laid-open patent publication No. 2000-285801; Japanese patent publication No. 46-20944; Japanese patent publication No. 44-26125; Yasuoka, Ishi “Pulsed electron source using a ferroelectric cathode”, J. Appl. Phys., Vol. 68, No. 5, p. 546-550 (1999); V. F. Puchkarev, G. A. Mesyats, “On the mechanism of emission from the ferroelectric ceramic cathode”, J. Appl. Phys., Vol. 78. No. 9, November 1995, p. 5633-5637; H. Riege, “Electron emission ferroelectrics—a review”, Nucl. Instr. And Meth. A340, p. 80-89 (1994)). If such electron emitters are incorporated in an FED, then they are arranged in a two-dimensional array, and a plurality of fluorescent bodies are disposed at predetermined spaced intervals in association with the respective electron emitters.

However, the straightness of conventional general electron emitters as disclosed in those documents, i.e., the extent to which emitted electrons travel straight toward a given object (e.g., a fluorescent body), is poor. For maintaining a desired current density with emitted electrons, it is necessary to apply a relatively high voltage to the electron emitter.

If conventional general electron emitters are incorporated in an FED, then the crosstalk is relatively large, i.e., the tendency that emitted electrons are applied to fluorescent bodies that are positioned adjacent to a fluorescent body corresponding to the emitted electrons is high, because the straightness of the electron emitters is poor. As a result, it is difficult to reduce the pitch of fluorescent bodies, and a grid needs to be provided for preventing electrons from being applied to adjacent fluorescent bodies.

### SUMMARY OF THE INVENTION

It is an object of the present invention to provide a light emission device which will not cause crosstalk and can emit light at a very low drive voltage in a relatively low vacuum atmosphere, and a field emission display having such light emission devices.

A light emission device according to a first invention comprises:

an electric field receiving member made of a dielectric material;

a first electrode disposed on one surface of the electric field receiving member;

a second electrode disposed on the one surface of the electric field receiving member, the second electrode and the first electrode jointly defining a slit; and

a fluorescent layer disposed on the second electrode.

With the light emission device according to the first invention, when a negative pulsed voltage is applied to the first electrode, electrons are emitted from a field concentration point in the vicinity of the slit. Since the electric field receiving member is made of a dielectric material, if the pulsed voltage is of negative polarity, then emitted electrons are drawn by a change in dipole moments in the interface between the first electrode to which the pulsed voltage is applied and the dielectric material, i.e., the field concentration point which is a triple point made up of the electrode, the dielectric material, and a vacuum. Since a plasma tends to be easily generated in the vicinity of the slit by the emitted electrons, electrons are multiplied. The emitted and multiplied electrons are applied to the fluorescent layer by grounding the second electrode, or applying a positive bias voltage to the second electrode, or applying a positive bias voltage to a third electrode if any. The fluorescent layer is excited to emit light.

Since the emitted electrons move only between the slit and the fluorescent layer, it is not necessary to take into account the straightness of the electrons, i.e., crosstalk, when the light emission device is in use. Accordingly, a voltage that is applied to achieve a desired current density is lower than required for an electron emitter, so that power consumption of the light emission device is greatly reduced. Because the light emission device employs the fluorescent body, the fluorescent body can be disposed near a region which emits electrons to excite the fluorescent body, so that electrons can reach the fluorescent body to excite the fluorescent body in a low vacuum where relatively many gas molecules are present. As a result, the light emission device can emit light at a very low drive voltage in a low vacuum. Inasmuch as the first and second electrodes, etc. can be formed on the electric field receiving member by thick-film printing, the light emission device according to the present invention is preferable also from the standpoints of durability and cost reduction.

A light emission device according to a second invention comprises:

an electric field receiving member made of a dielectric material;

a first electrode disposed on one surface of the electric field receiving member;

a second electrode disposed on the one surface of the electric field receiving member, the second electrode and the first electrode jointly defining a slit;

an electrically conductive coating layer disposed on the first electrode, the second electrode, and the slit; and

a fluorescent layer disposed on the electrically conductive coating layer.

According to the second invention, when a negative pulsed voltage is applied to the first electrode, electrons are emitted from a field concentration point in the vicinity of the slit. Since the electric field receiving member is made of a dielectric material, if the pulsed voltage is of negative polarity, then emitted electrons are drawn by a change in dipole moments in the interface between the first electrode to which the pulsed voltage is applied and the dielectric material, i.e., the field concentration point which is a triple point made up of the electrode, the dielectric material, and a vacuum. Since a plasma tends to be easily generated in the vicinity of the slit by the emitted electrons, electrons are multiplied. The emitted and multiplied electrons are applied to the fluorescent layer by grounding the second electrode, or applying a positive bias voltage to the second electrode, or applying a positive bias voltage to a third electrode if any. The fluorescent layer is excited to emit light. The electrically conductive coating layer disposed on the first electrode, the second electrode, and the slit is effective to further reduce a voltage that is applied to the light emission device.

According to the second invention, as with the first invention, since the emitted electrons move only between the slit and the fluorescent layer, it is not necessary to take into account the straightness of the electrons, i.e., crosstalk, when the light emission device is in use. Accordingly, a voltage that is applied to achieve a desired current density is lower than required for an electron emitter, so that power consumption of the light emission device is greatly reduced. Because the light emission device employs the fluorescent body, the fluorescent body can be disposed near a region which emits electrons to excite the fluorescent body, so that electrons can reach the fluorescent body to excite the fluorescent body in a low vacuum where relatively many gas molecules are present. As a result, the light emission device can emit light at a very low drive voltage in a low vacuum. Inasmuch as the first and second electrodes, etc. can be formed on the electric field receiving member by thick-film printing, the light emission device according to the present invention is preferable also from the standpoints of durability and cost reduction.

In order to concentrate the electric field for facilitating the emission of electrons, at least one of the first electrode and the second electrode should preferably have at least one of a convexity and a concavity. The convexity and the concavity are formed regularly or irregularly to a desired shape with at least one of a straight line and a curved line. If the convexity and the concavity are formed regularly or irregularly with a straight line only, at least one of the first electrode and the second electrode has an angular portion with an acute angle.

In order to concentrate the electric field for facilitating the emission of electrons, the light emission device may comprise at least one of a pinhole defined in at least one of the first electrode and the second electrode, and a land disposed in the slit in electrically insulated relation to the first electrode and the second electrode and made of a material which is the same as the material of the first electrode and the second electrode. The pinhole and the land are also formed regularly or irregularly to a desired shape with at least one of a straight line and a curved line.

In order to greatly reduce the applied voltage, the electric field receiving member has a specific dielectric constant of 1000 or greater, and/or the slit has a width in a range between 0.1 μm and 500 μm. In order to further reduce the applied voltage, the slit has a width in a range between 0.1 μm and 50 μm, or preferably the slit a width in a range between 0.1 μm and 10 μm. More preferably, the slit has a width in a range between 0.1 μm and 1 μm. The electrons can be emitted by a low applied voltage such as of about 10 V.

For achieving easier machinability and insulation between the first electrode and the second electrode, the width of the slit may have a lower limit of 0.1 μm. For emitting electrons at a lower voltage, reducing the size of the circuit, and reducing the cost, and from the standpoint of the service life of the drive electrodes (the first or second electrode), the width of the slit may have an upper limit of 1 μm.

A field emission display according to a first invention comprises:

an electric field receiving member made of a dielectric material;

a first electrode disposed on one surface of the electric field receiving member;

a second electrode disposed on the one surface of the electric field receiving member, the second electrode and the first electrode jointly defining a slit; and

a fluorescent layer disposed on the second electrode.

With the field emission display according to the first invention, since the light emission devices emit light by themselves when the FED displays information, the FED is not required to have fluorescent bodies, and as a result, it is not necessary to take into account the pitch of fluorescent bodies and to provide a grid. As a consequence, the FED according to the present invention is preferable from the standpoints of higher definition, increased resolution, smaller size, and cost reduction. Furthermore, since the light emission devices can be used in a low vacuum, a sealing structure for keeping a vacuum space in the FED is simple and small in size. Thus, it is very advantageous for making the FED low in profile.

A field emission display according to a second invention comprises:

an electric field receiving member made of a dielectric material;

a first electrode disposed on one surface of the electric field receiving member;

a second electrode disposed on the one surface of the electric field receiving member, the second electrode and the first electrode jointly defining a slit;

an electrically conductive coating layer disposed on the first electrode, the second electrode, and the slit; and

a fluorescent layer disposed on the electrically conductive coating layer.

With the field emission display according to the second invention, as with the first invention, since the light emission devices emit light by themselves when the FED displays information, the FED is not required to have fluorescent bodies, and as a result, it is not necessary to take into account the pitch of fluorescent bodies and to provide a grid. As a consequence, the FED according to the present invention is preferable from the standpoints of higher definition, increased resolution, smaller size, and cost reduction. Furthermore, since the light emission devices can be used in a low vacuum, a sealing structure for keeping a vacuum space in the FED is simple and small in size. Thus, it is very advantageous for making the FED low in profile. The electrically conductive coating layer disposed on the first electrode, the second electrode, and the slit is effective to further reduce a voltage that is applied to the light emission device.

Preferably, the field emission display further comprises a substrate, the two-dimensional array of light emission devices being integrally formed with the substrate. An optimum vacuum level will be described below. The vacuum level should preferably in the range from 10² to 10⁻⁶ Pa and more preferably in the range from 10⁻³ to 10⁻⁵ Pa. In a lower vacuum, many gas molecules would be present in the space, and a plasma can easily be generated. If an intensive plasma were generated, many positive ions thereof would impinge upon the first electrode and damage the same.

In a higher vacuum, though electrons would be liable to be emitted from the triple point, structural body supports and vacuum seals would be large in size, posing disadvantages on efforts to make the electron emission device lower in profile and smaller in size.

As can be seen from the above description, according to the first invention, when a negative pulsed voltage is applied to the first electrode, electrons are emitted from a field concentration point in the vicinity of the slit. Since the electric field receiving member is made of a dielectric material, if the pulsed voltage is of negative polarity, then emitted electrons are drawn by a change in dipole moments in the interface between the first electrode to which the pulsed voltage is applied and the dielectric material, i.e., the field concentration point which is a triple point made up of the electrode, the dielectric material, and a vacuum. Since a plasma tends to be easily generated in the vicinity of the slit by the emitted electrons, electrons are multiplied. The emitted and multiplied electrons are applied to the fluorescent layer by grounding the second electrode, or applying a positive bias voltage to the second electrode, or applying a positive bias voltage to a third electrode if any. The fluorescent layer is excited to emit light. The light emission device can thus emit light at a very low drive voltage in a relatively low vacuum without causing crosstalk.

According to the second invention, when a negative pulsed voltage is applied to the first electrode, electrons are emitted from a field concentration point in the vicinity of the slit. Since the electric field receiving member is made of a dielectric material, if the pulsed voltage is of negative polarity, then emitted electrons are drawn by a change in dipole moments in the interface between the first electrode to which the pulsed voltage is applied and the dielectric material, i.e., the field concentration point which is a triple point made up of the electrode, the dielectric material, and a vacuum. Since a plasma tends to be easily generated in the vicinity of the slit by the emitted electrons, electrons are multiplied. The emitted and multiplied electrons are applied to the fluorescent layer by grounding the second electrode, or applying a positive bias voltage to the second electrode, or applying a positive bias voltage to a third electrode if any. The fluorescent layer is excited to emit light. The electrically conductive coating layer disposed on the first electrode, the second electrode, and the slit is effective to further reduce a voltage that is applied to the light emission device. According to the second invention, therefore, the light emission device can emit light at a very low drive voltage in a relatively low vacuum without causing crosstalk.

Said electric fielf receiving member may be of a pizoelectric material, an anti-ferroelectric material, or an electrostrictive material.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1A is a vertical longitudinal sectional view of a light emission device according to a first embodiment of a first invention.

FIG. 1B is a cross-sectional view taken alone line IB-IB of FIG. 1A.

FIG. 2 is a view of a light emission device according to a second embodiment of the first invention.

FIG. 3 is a view of a light emission device according to a first embodiment of a second invention.

FIG. 4 is a view of a light emission device according to a second embodiment of the second invention.

FIG. 5A is a vertical longitudinal sectional view of a light emission device according to an embodiment.

FIG. 5B is a plan view of the light emission device shown in FIG. 5A.

FIG. 6A is a vertical longitudinal sectional view of a light emission device according to still another embodiment of the invention.

FIG. 6B is a plan view of the light emission device shown in FIG. 6A.

FIG. 7A is a vertical longitudinal sectional view of a light emission device according to an embodiment.

FIG. 7B is a cross-sectional view taken along line VIIB-VIIB of FIG. 7A.

FIG. 8 is an enlarged microscopic photographic representation of a portion of FIG. 7B.

FIG. 9 is a diagram illustrating the enlarged microscopic photographic representation shown in FIG. 8.

FIG. 10A is a vertical longitudinal sectional view of a light emission device according to another embodiment of the present invention.

FIG. 10B is a cross-sectional view taken alone line XB-XB of FIG. 10A.

FIG. 11A is a vertical longitudinal sectional view of a light emission device according to still another embodiment of the present invention.

FIG. 11B is a cross-sectional view taken alone line XIB-XIB of FIG. 11A.

FIG. 12A is a vertical longitudinal sectional view of a light emission device according to yet another embodiment of the present invention.

FIG. 12B is a cross-sectional view taken alone line XIIB-XIIB of FIG. 12A.

FIG. 13A is a vertical longitudinal sectional view of a light emission device according to yet still another embodiment of the present invention.

FIG. 13B is a cross-sectional view taken alone line XIIIB-XIIIB of FIG. 13A.

FIG. 14 is a view of an FED according to an embodiment of the present invention.

### DESCRIPTION OF THE PREFERRED EMBODIMENTS

Embodiments of a light emission device according to the present invention and a field emission display having such light emission devices will be described in detail below with reference to the drawings. Identical parts are denoted by identical reference characters throughout views.

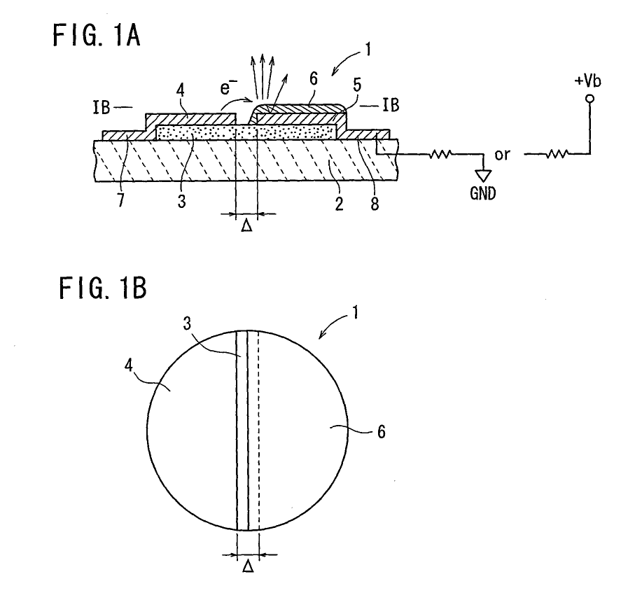

FIG. 1A is a vertical longitudinal sectional view of a light emission device according to a first embodiment of a first invention, and FIG. 1B is a cross-sectional view taken alone line IB-IB of FIG. 1A. A light emission device 1 according to the present embodiment is formed on a substrate 2, and has an electric field receiving member 3 made of a dielectric material, a drive electrode 4 as a first electrode disposed on one surface of the electric field receiving member 3, a common electrode 5 as a second electrode, the common electrode 5 and the drive electrode 4 jointly defining a slit, and a fluorescent layer 6 disposed on the common electrode 5. The common electrode 5 is connected to ground or a bias voltage +Vb is applied to the common electrode 5. If the bias voltage is applied, electrons can be directed to the fluorescent layer 6 with high probability.

The substrate 2 should preferably be made of an electrically insulating material for electrically isolating an interconnection 7 electrically connected to the drive electrode 4 and an interconnection 8 electrically connected to the common electrode 5 from each other.

The substrate 2 may thus be made of a material such as an enameled material, e.g., a highly heat-resistant metal whose surface is covered with a ceramics material such as glass or the like. However, the substrate 2 is most preferably be made of ceramics.

The ceramics that the substrate 2 may be made of includes stabilized zirconium oxide, aluminum oxide, magnesium oxide, titanium oxide, spinel, mullite, aluminum nitride, silicon nitride, glass, and mixtures thereof. Of these materials, aluminum oxide and stabilized zirconium oxide are preferable from the standpoint of strength and rigidity. In particular, stabilized zirconium oxide is preferable as the mechanical strength is high, the tenacity is high, and its chemical reaction with the drive electrode 4 and the common electrode 5 is relatively low. Stabilized zirconium oxide includes stabilized zirconium oxide and partially stabilized zirconium oxide. Since stabilized zirconium oxide has a crystalline structure such as a cubic system, no phase transition occurs therein.

Zirconium oxide undergoes a phase transition between a monoclinic system and a cubic system at about 1000° C., and tends to crack upon such a phase transition. Stabilized zirconium oxide contains 1-30 mol. % of a stabilizer such as calcium oxide, magnesium oxide, yttrium oxide, scandium oxide, ytterbium oxide, cerium oxide, an oxide of a rare earth metal, or the like. It is preferable for the stabilizer to contain yttrium oxide in order to increase the mechanical strength of the substrate 2. In such a case, the stabilizer should preferably contain 1.5-6 mol. %, more preferably 2-4 mol. %, of yttrium oxide, and further contain 0.1-5 mol. % of aluminum oxide.

The crystalline system may be a mixture of a cubic system and a monoclinic system, a mixture of a tetragonal system and a monoclinic system, a mixture of a cubic system, a tetragonal system, and a monoclinic system, or the like. Of these systems, the crystalline system should most preferably be a tetragonal system or a mixture of a tetragonal system and a cubic system from the standpoint of strength, tenacity, and durability.

If the substrate 2 is made of ceramics, then the substrate 2 is made up of a relatively large number of crystal grains. In order to increase the mechanical strength of the substrate 2, the crystal grains should preferably have an average grain size in the range from 0.05 to 2 μm, more preferably in the range from 0.1 to 1 μm.

The dielectric material of the electric field receiving member 3 preferably comprises a dielectric material having a relatively high specific dielectric constant, e.g., 1000 or greater. Such a dielectric material may be barium titanate, lead zirconate, lead magnesium niobate, lead nickel niobate, lead zinc niobate, lead manganese niobate, lead magnesium tantalate, lead nickel tantalate, lead antimony tinate, lead titanate, barium titanate, lead magnesium tungstenate, lead cobalt niobate, etc., ceramics containing a desired combination of these compounds, materials whose main constituent contains 50 weight % or more of these compounds, or materials containing the above ceramics and oxides of lanthanum, calcium, strontium, molybdenum, tungsten, barium, niobium, zinc, nickel, manganese, etc., any combinations thereof, or other compounds added thereto. For example, a two-component n-PMN-mPT compound (n, m represent molar ratios) of lead magnesium niobate (PMN) and lead titanate (PT) has its Curie point lowered and its specific dielectric constant increased at room temperature when the molar ratio of PMN is increased. Particularly, if n=0.85-1.0, m=1.0-n, then the specific dielectric constant has a preferably value of 3000 or higher. For example, if n=0.91, m=0.09, then the specific dielectric constant of 15000 at room temperature is achieved, and if n=0.95, m=0.05, the specific dielectric constant of 20000 at room temperature is achieved. A three-component compound of lead magnesium niobate (PMN), lead titanate (PT), and lead zirconate (PZ) may have its specific dielectric constant increased by making the compound have a composition in the vicinity of a morphotropic phase boundary (MPB) between a tetragonal system and a pseudo-cubic system or a tetragonal system and a rhombohedral system, as well as by increasing the molar ratio of PMN. For example, the specific dielectric constant of 5500 is achieved preferably with PMN:PT:PZ=0.375:0.375:0.25, and the specific dielectric constant of 4500 is achieved preferably with PMN:PT:PZ=0.5:0.375:0.125. It is also preferable to increase the dielectric constant by mixing the above dielectric materials with a metal such as platinum insofar as electric insulation is maintained. For example, the dielectric materials are mixed with 20 weight % of platinum.

Each of the drive electrode 4 and the common electrode 5 is of a semicircular shape and is made of Au in the form of a film having a thickness of 3 μm. For producing a field emission phenomenon, the width Δ of the slit is selected to be 500 μm or less. If the light emission device according to the present invention is driven by a driver IC for use in commercially available plasma displays, fluorescent display tubes, or liquid-crystal displays, then the width Δ of the slit should preferably 20 μm or less.

A negative pulsed voltage is applied to the drive electrode 4 from a power supply (not shown) through an interconnection 7 which extends from the reverse side of the substrate 2. The common electrode 5 is kept at a predetermined potential (e.g., a ground potential or a bias potential) through an interconnection 8 which extends from the reverse side of the substrate 2. It is preferable to connect a resistor between the common electrode 5 and ground for suppressing an excessive current.

The fluorescent layer 6 is made of a known fluorescent material for use in color displays.

Operation of the light emission device according to the present embodiment will be described below. When a negative pulsed voltage is applied to the drive electrode 4, electrons are emitted from a field concentration point in the vicinity of the slit. Since the electric field receiving member 3 is made of a dielectric material, if the pulsed voltage is of negative polarity, then emitted electrons are drawn by a change in dipole moments in the interface between the drive electrode 4 to which the pulsed voltage is applied and the dielectric material, i.e., the field concentration point which is a triple point made up of the electrode 4, the dielectric material 3, and a vacuum. Since a plasma tends to be easily generated in the vicinity of the slit by the emitted electrons, electrons are multiplied. The emitted and multiplied electrons are applied to the fluorescent layer 6 by the common electrode 5 which is grounded or to which a bias voltage is applied. The fluorescent layer 6 is excited to emit light as indicated by the arrows. The drive electrode 4 and the common electrode 5 should preferably have a mirror-finish surface as it reflects emitted light outwardly for greater luminance.

Since the emitted electrons move from the slit only to the fluorescent layer 6, it is not necessary to take into account the straightness of the electrons, i.e., crosstalk, when the light emission device is in use. Accordingly, a voltage that is applied to achieve a desired current density is lower than required for an electron emitter, so that power consumption of the light emission device is greatly reduced. Because the light emission device 1 employs the fluorescent layer 6 by itself, the fluorescent layer 6 can be disposed near a region which emits electrons to excite the fluorescent layer 6, so that electrons can reach the fluorescent body to excite the fluorescent body in a low vacuum where relatively many gas molecules are present. As a result, the light emission device can emit light at a very low drive voltage in a low vacuum. Inasmuch as the drive electrode 4 and the common electrode 5, etc. can be formed on the electric field receiving member by thick-film printing, the light emission device according to the present invention is preferable also from the standpoints of durability and cost reduction.

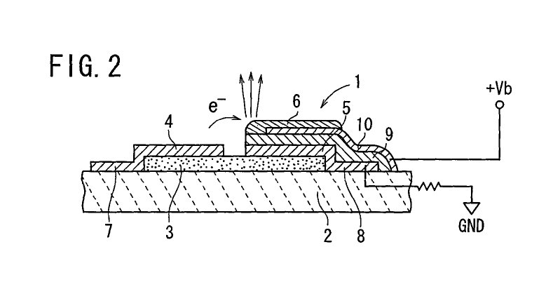

FIG. 2 is a vertical longitudinal sectional view of a light emission device according to a second embodiment of the first invention. Those parts in FIG. 2 which are identical to those shown in FIG. 1 are denoted by identical reference characters, and will not be described in detail below. The light emission device shown in FIG. 2 differs from the light emission device shown in FIG. 1 in that an insulating layer 9 and a collector electrode 10 are interposed between the common electrode 5 and the fluorescent layer 6, the insulator layer 9 is positioned adjacent to the common electrode 5, the collector electrode 10 is positioned adjacent to the fluorescent layer 6, the common electrode 5 is connected to ground, and a bias voltage +Vb is applied to the collector electrode 10. By applying the bias voltage +Vb to the collector electrode 10, electrons are applied more effectively to the fluorescent layer 6.

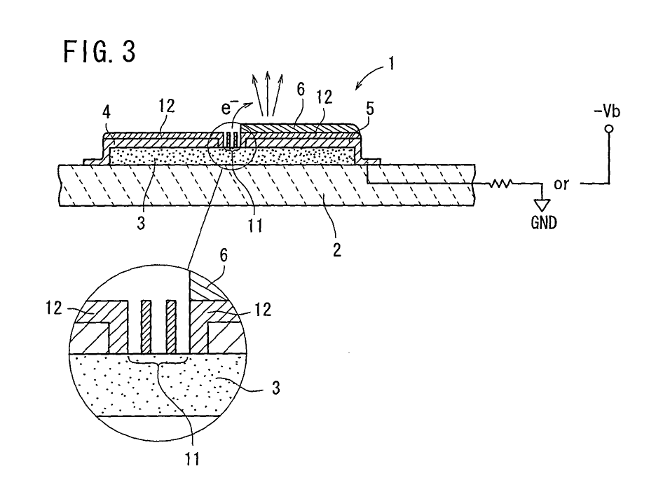

FIG. 3 is a vertical longitudinal sectional view of a light emission device according to a first embodiment of a second invention. Those parts in FIG. 3 which are identical to those shown in FIG. 1 are denoted by identical reference characters, and will not be described in detail below. The light emission device shown in FIG. 3 differs from the light emission device shown in FIG. 1 in that an electrically conductive coating layer 12 is disposed on the drive electrode 4, the common electrode 5, and a slit 11 between the drive electrode 4 and the common electrode 5, and the fluorescent layer 6 is disposed on the surface of the electrically conductive coating layer 12 which corresponds to the common electrode 5. The electrically conductive coating layer 12 thus provided is effective to further reduce the voltage that is applied to the light emission device 1.

In the present embodiment, the electrically conductive coating layer 12 is not disposed uniformly on the drive electrode 4, the common electrode 5, and the slit 11, but has slit-like cracks in its portion aligned with the slit 11. The electrically conductive coating layer 12 should preferably have slit-like cracks or minute holes defined therein. An electric field can concentrate on the slit-like cracks or minute holes in the electrically conductive coating layer 12 for emitting electrons at a low applied voltage. As a result, the power consumption of the light emission device is lowered, and the cost thereof is also lowered by reducing the size of the circuit and dispensing with high-voltage components. The slit-like cracks may be formed by forming the electrically conductive coating layer 12 of uniform thickness and thereafter applying a high voltage between the drive electrode 4 and the common electrode 5. The minute holes may be formed in the surface of the electrically conductive coating layer 12 by printing a material such as porous carbon in advance.

The electrically conductive coating layer 12 serves to further lower the voltage applied to the light emission device 1, and comprises a layer of carbon having a thickness of 3 μm, for example. However, the electrically conductive coating layer 12 may be made of an electric conductor that is resistant to a high-temperature oxidizing atmosphere, e.g., a single metal, an alloy, a mixture of insulating ceramics and a single metal, a mixture of insulating ceramics and an alloy, or the like. Preferably, the electrically conductive coating layer 12 should be made of a precious metal having a high melting point such as platinum, palladium, rhodium, molybdenum, or the like, a material whose main component comprises an alloy of silver and palladium, an alloy of silver and platinum, an alloy of platinum and palladium, or the like, or a cermet of platinum and a ceramics material. More preferably, the electrically conductive coating layer 12 should be made of a material whose main component comprises platinum or a platinum-based alloy. The electrically conductive coating layer 6 may also be made of a graphite material such as thin-film diamond, diamond-like carbon, carbon nanotube, for example. The ceramics material to be added to the electrically conductive coating layer material should preferably be of a proportion ranging from 5 to 30 volume %. The electrically conductive coating section 104 should preferably have a resistance ranging from several kilohms to 100 kilohms. The electrically conductive coating section 104 is formed of evaporated carbon (a specific example is an evaporated layer of “CARBON 5PC” manufactured by Sanyu Kogyo Co.), filled carbon (a specific example is a filled layer of “FW200” manufactured by Degussa Co.), printed carbon, or the like.

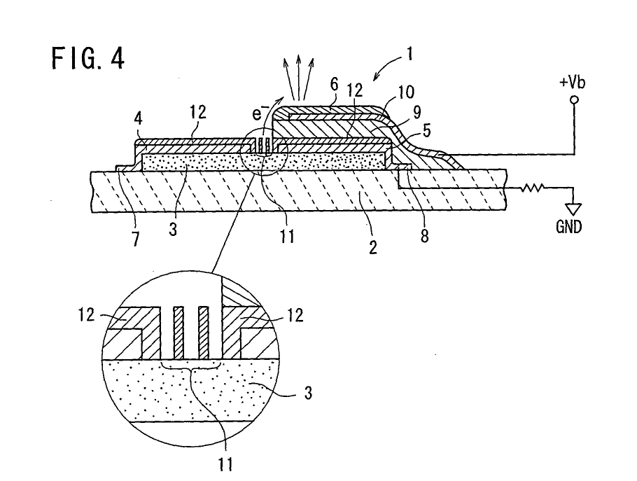

FIG. 4 is a vertical longitudinal sectional view of a light emission device according to a second embodiment of the second invention. Those parts in FIG. 4 which are identical to those shown in FIG. 3 are denoted by identical reference characters, and will not be described in detail below. The light emission device shown in FIG. 4 differs from the light emission device shown in FIG. 3 in that an insulating layer 9 and a collector electrode 10 are interposed between the common electrode 5 and the fluorescent layer 6, the insulating layer 9 is positioned adjacent to the common electrode 5, the collector electrode 10 is positioned adjacent to the fluorescent layer 6, the common electrode 5 is connected to ground, and a bias voltage +Vb is applied to the collector electrode 10. By applying the bias voltage +Vb to the collector electrode 10, electrons are applied more effectively to the fluorescent layer 6.

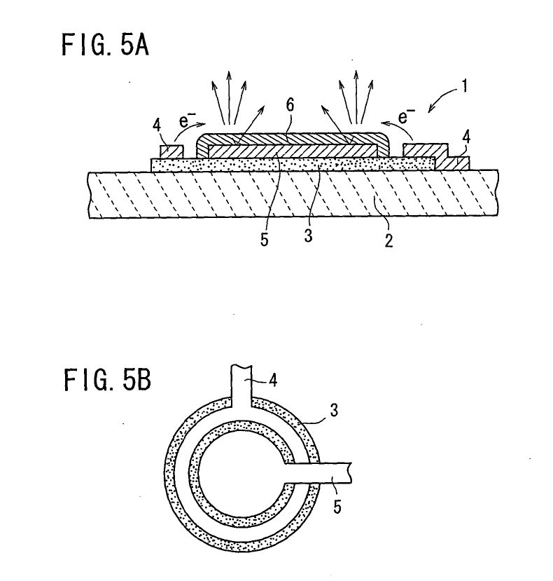

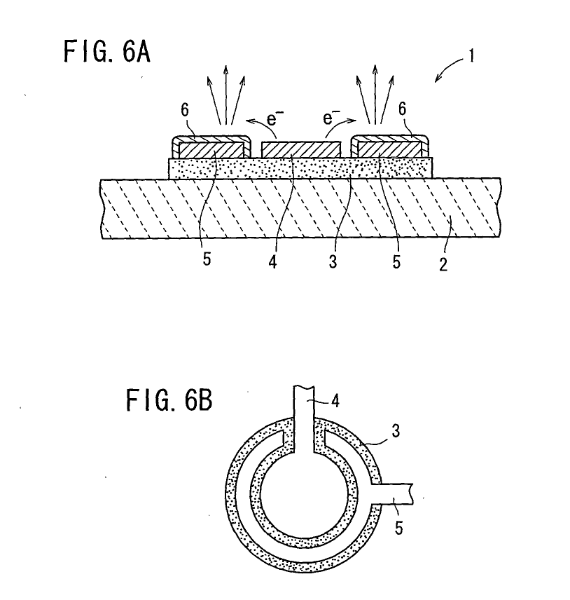

FIGS. 5A, 5B and 6A, 6B show light emission devices according to other embodiments of the present invention. In FIGS. 5A, 5B and 6A, 6B, the light emission device 1 is of the structure according to the first embodiment of the first invention. However, the light emission device 1 may be of any of the structures according to the other embodiment of the first invention and the other embodiments of the second invention. Those parts in FIGS. 5A, 5B and 6A, 6B which are identical to those shown in FIG. 1 are denoted by identical reference characters, and will not be described in detail below.

FIG. 5A is a vertical longitudinal sectional view of a light emission device according to an embodiment, and FIG. 5B is a plan view of the light emission device shown in FIG. 5A. In the embodiment shown in FIGS. 5A and 5B, the common electrode 5 is circular in shape, the drive electrode 4 is annular in shape and disposed around the circular common electrode 5, and the slit 11 defined between the drive electrode 4 and the common electrode 5 is annular in shape. FIG. 6A is a vertical longitudinal sectional view of an embodiment, and FIG. 6B is a plan view of the light emission device shown in FIG. 6A. In the embodiment shown in FIGS. 6A and 6B, the drive electrode 4 is circular in shape, the common electrode 5 is annular in shape and disposed around the circular drive electrode 4, and the slit 11 defined between the drive electrode 4 and the common electrode 5 is annular in shape. In either one of these embodiments, the length of the slit 11 can be increased to increase the number of generated electrons.

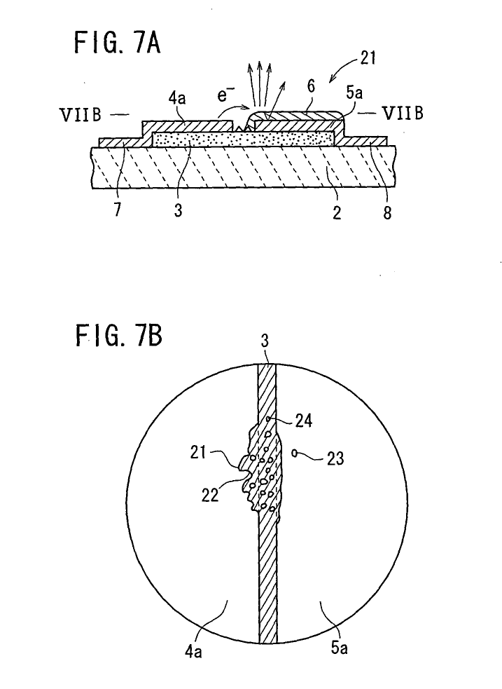

FIGS. 7A, 7B through 13A, 13B show light emission devices according to other embodiments of the present invention. FIG. 7A is a vertical longitudinal sectional view of a light emission device according to an embodiment, and FIG. 7B is a cross-sectional view taken along line VIIB-VIIB of FIG. 7A. According to the present embodiment, a drive electrode 4a and a common electrode 5a have a concavity 21, a convexity 22, and a pinhole 23. Lands 24 are disposed in the slit in electrically insulated relation to the drive electrode 4a and the common electrode 5a, and are made of a material (e.g., Au) which is identical to the material that the drive electrode 4a and the common electrode 5a are made of.

According to the second embodiment, an electric field is concentrated on the concavity 21, the convexity 22, the pinhole 23, and the lands 24 for facilitating the emission of electrons. Therefore, the drive voltage for the light emission device 21 can further be lowered.

The concavity 21, the convexity 22, the pinhole 23, and the lands 24 are formed by making a drive electrode and a common electrode, which are semicircular in shape, of Au with a slit width of 10 μm, for example, on a dielectric material (having a dielectric constant of 5500), and thereafter applying a pulsed voltage of 250 V in 5 μseconds several times to the drive electrode and the common electrode with a resistor of 10 ohms connected between the common electrode and ground. If the light emission device shown in FIGS. 7A and 7B is to be used, then a resistor of 10 kilohms is connected between the common electrode and ground.

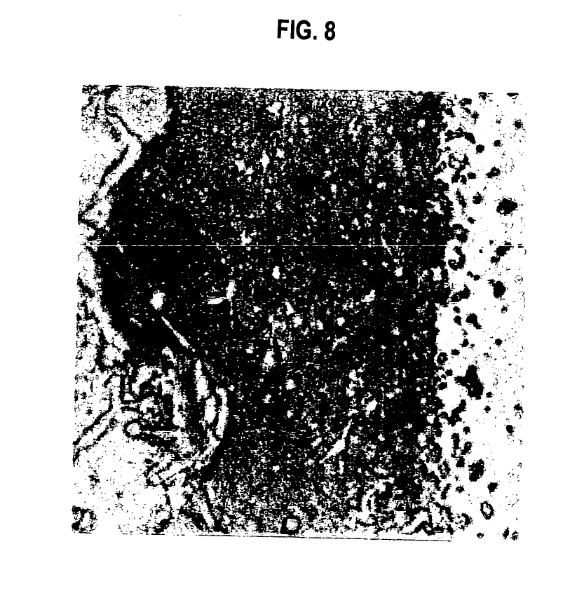

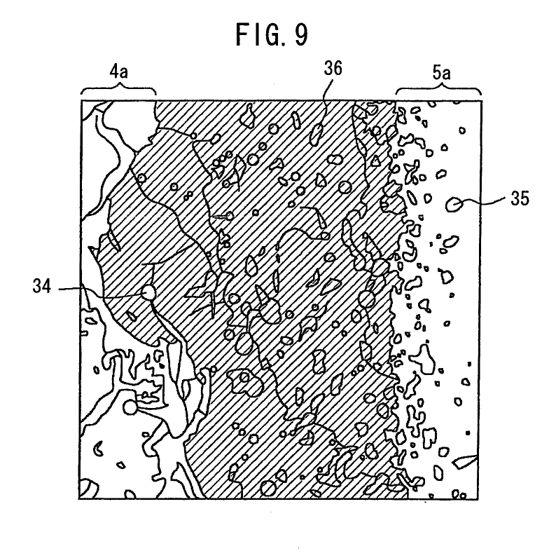

FIG. 8 is an enlarged microscopic photographic representation of a portion of the light emission device shown in FIG. 7B, and FIG. 9 is a diagram illustrating the enlarged microscopic photographic representation shown in FIG. 8. In FIG. 9, the slit is shown hatched. The drive electrode 4a has a convexity 34, the common electrode 5a has a pinhole, and the slit has lands.

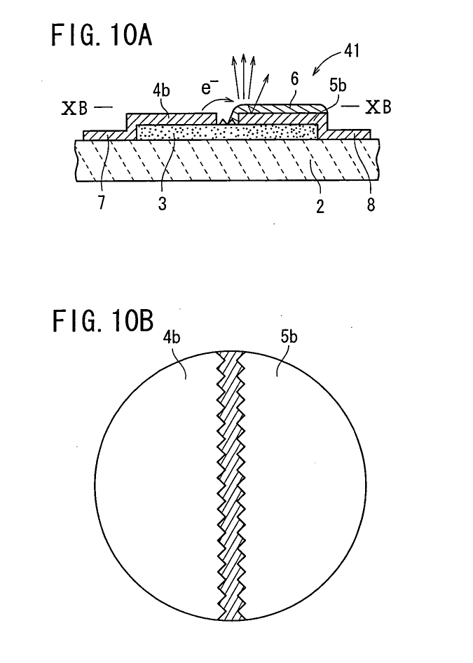

FIG. 10A is a vertical longitudinal sectional view of a light emission device according to another embodiment of the present invention, and FIG. 10B is a cross-sectional view taken alone line XB-XB of FIG. 10A. According to the present embodiment, each of a drive electrode 4b and a common electrode 5b of a light emission device 41 has a regularly formed saw-toothed portion facing the slit. Since an electric field is concentrated on the saw-toothed portion, facilitating the emission of electrons, the drive voltage for the light emission device 41 can further be lowered.

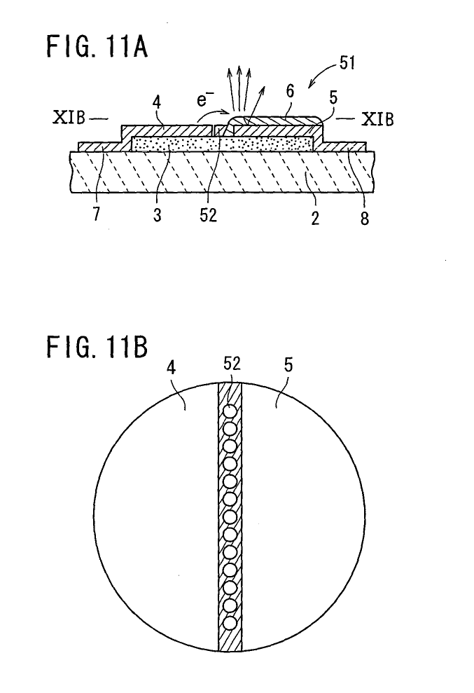

FIG. 11A is a vertical longitudinal sectional view of a light emission device according to still another embodiment of the present invention, and FIG. 11B is a cross-sectional view taken alone line XIB-XIB of FIG. 11A. According to the present embodiment, a light emission device 51 has a regularly arranged array of circular lands 52 in the slit. Since an electric field is concentrated on the lands 52, facilitating the emission of electrons, the drive voltage for the light emission device 51 can further be lowered.

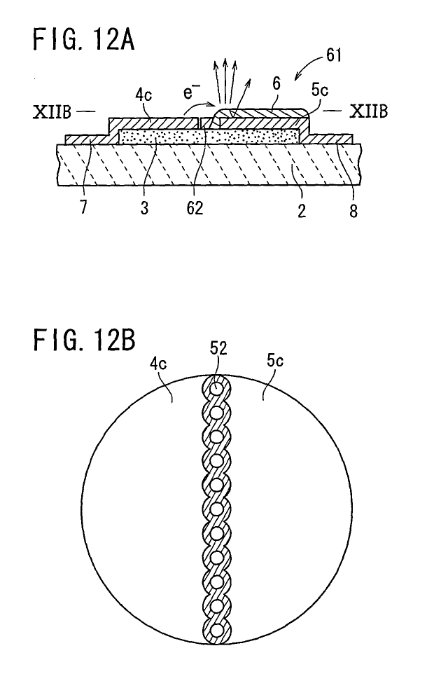

FIG. 12A is a vertical longitudinal sectional view of a light emission device according to yet another embodiment of the present invention, and FIG. 12B is a cross-sectional view taken alone line XIIB-XIIB of FIG. 12A. According to the present embodiment, a light emission device 61 has a regularly arranged array of circular lands 62 in the slit and each of a drive electrode 4c and a common electrode 5c has a regularly arranged array of sharp teeth facing the slit. Since an electric field is concentrated on the sharp teeth and the lands 62, facilitating the emission of electrons, the drive voltage for the light emission device 61 can further be lowered.

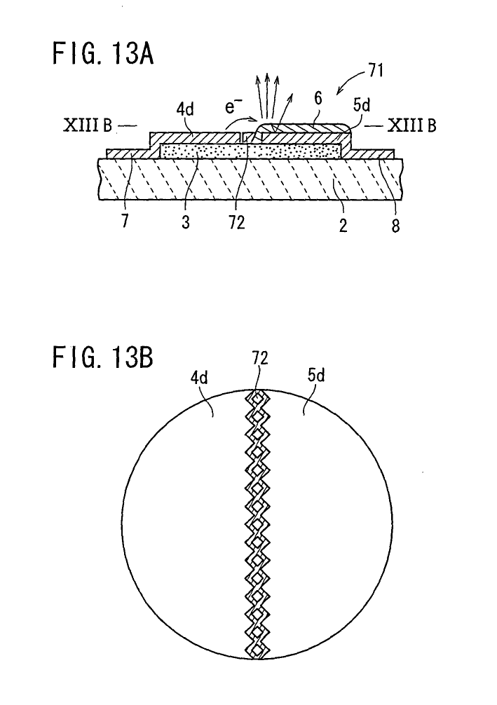

FIG. 13A is a side elevational view of a light emission device according to yet still another embodiment of the present invention, and FIG. 13B is a cross-sectional view taken alone line XIIIB-XIIIB of FIG. 13A. According to the present embodiment, a light emission device 71 has a regularly arranged array of rhombic lands 72 in the slit and each of a drive electrode 4d and a common electrode 5d has a regularly formed saw-toothed portion facing the slit. Since an electric field is concentrated on the sharp teeth and the lands 72, facilitating the emission of electrons, the drive voltage for the light emission device 71 can further be lowered.

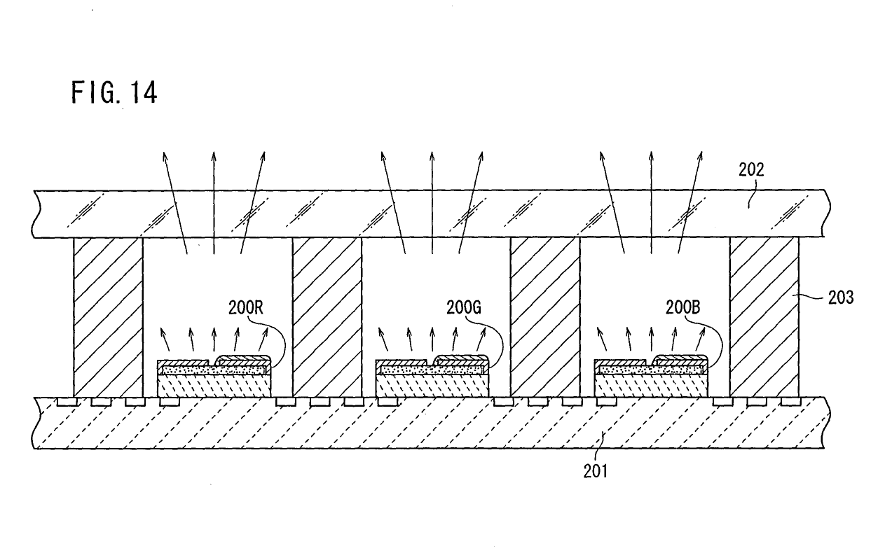

FIG. 14 is a view showing an FED according to an embodiment of the present invention. The FED comprises a two-dimensional array of light emission devices 200R, 200G, 200B, a substrate 201 on which the light emission devices 200R, 200G, 200B are disposed, a transparent substrate 202 disposed at a predetermined spaced interval from the light emission devices 200R, 200G, 200B and made of glass, for example, and spacers 203 which provides a space in the direction of the thickness of the FED.

According to the present embodiment, the light emission devices 200R, 200G, 200B employ a red fluorescent body, a green fluorescent body, and a blue fluorescent body as a fluorescent layer, and the substrate 201 is made of a material which is the same as the substrate 2 shown in FIG. 1. Each of the light emission devices 200R, 200G, 200B has the structure shown in FIG. 1, but may have any of the structures shown in FIGS. 2-6A, 6B.

According to the present embodiment, since the light emission devices 200R, 200G, 200B emit light by themselves when the FED displays information, the FED is not required to have fluorescent bodies, and as a result, it is not necessary to take into account the pitch of fluorescent bodies and to provide a grid. As a consequence, the FED according to the present invention is preferable from the standpoints of higher definition, increased resolution, smaller size, and cost reduction. Furthermore, since the light emission devices can be used in a low vacuum, a sealing structure for keeping a vacuum space in the FED is simple and small in size. It is very advantageous for making the FED low in profile.

The present invention is not limited to the above embodiments, but many changes and modifications may be made therein.

For example, the light emission device according to the present invention may be used in other applications than the FED, e.g., high-luminance, high-efficiency light sources such as light sources for use in projectors, chip light sources, traffic signal devices, or alternatives to LEDs such as backlight units in small-size liquid-crystal display units such as cellular phones. For producing a field concentration point, a slit having a width ranging between 0.1 μm and 500 μm may preferably be defined between the drive electrode and the common electrode, a convexity and a concavity which are formed regularly or irregularly to a desired shape with at least one of a straight line and a curved line may be disposed on at least one of the drive electrode and the common electrode, lands may be formed in the slit, and/or the drive electrode and the common electrode may be shaped as desired insofar as at least one of the drive electrode and the common electrode has a pinhole.

The width d of the slit between the drive electrode and the common electrode will be considered below. In order to reduce the voltage V that is applied to the light emission device to cause the light emission device to emit electrons, the width of the slit should preferably be relatively small. For emitting electrons, an electric field having a predetermined value E or greater needs to be generated in a location where the electric field is concentrated. Since the electric field E is determined by:

E=V/d

increasing the electric field E needs to increase the voltage V and/or reduce the width d of the slit.

If the voltage V is increased, then

(a) since the voltage applied to the drive circuit for the light emission device is increased, it is difficult to reduce the size of the drive circuit, and the overall apparatus which has the light emission device and the drive circuit therefor becomes expensive to manufacture, and

(b) positive ions generated in the plasma atmosphere gains energy under the voltage V, impinges upon the drive electrode, and hence tends to damage the drive electrode.

As a result, for increasing the electric field E, it is preferable to reduce the width d of the slit without increasing the voltage V.

While it is preferable to reduce the width d of the slit as much as possible, according to the present invention, it is not necessary to reduce the width d of the slit so much as with the electron emitter used in the conventional FEDs for the emission of electrons. Specifically, with an electron emitter based on the principles of field emission, the electric field E needs to be of about 5×10⁹ V/m, and the width d of the slit needs to be of 20 nm in order to keep the voltage V at 100 V or less. With the light emission device according to the present invention, on the other hand, it is sufficient for the width d of the slit to be of 20 μm in order to keep the voltage V at 100 V or less. As a result, the slit can be formed by an inexpensive slitting and patterning process.

According to the present invention, the width d of the slit is in the range between 0.1 μm and 500 μm. For further lowering the applied voltage, the width d of the slit is kept in the range between 0.1 μm and 50 μm, preferably in the range between 0.1 μm and 10 μm, or more preferably in the range between 0.1 μm and 1 μm. With this slit width, the light emission device is capable of emitting electrons at a low applied voltage of about 10 V.

For achieving easier machinability and insulation between the first electrode and the second electrode, the width d of the slit may have a lower limit of 0.1 μm. For emitting electrons at a lower voltage, reducing the size of the circuit, and reducing the cost, and from the standpoint of the service life of the drive electrodes, the width d of the slit may have an upper limit of 1 μm.

In the above embodiments, the substrate is made of ceramics. However, the substrate may comprise a glass substrate, a metal plate, or a silicon substrate, or may be made of a dielectric material itself. If a glass substrate is employed, then the light emission device may be constructed as a large panel, and the circuit may be fabricated using TFT. If a metal layer is employed, then an insulating layer is required. If a silicon substrate is employed, then the circuit can be formed with ease. If the substrate is made of a dielectric material itself, then the substrate itself serves as an electric field receiving member by itself, and a drive electrode and a common electrode can directly be formed on the substrate.

In the above embodiments, the electrically conductive coating layer is disposed between the drive electrode (first electrode), the common electrode (second electrode), and the slit, and the electron passage layer. However, the electrically conductive coating layer may be dispensed with. According to such a modification, the drive electrode 4 may be made of an electric conductor that is resistant to a high-temperature oxidizing atmosphere, e.g., a single metal, an alloy, a mixture of insulating ceramics and a single metal, a mixture of insulating ceramics and an alloy, or the like. Preferably, the electrically conductive coating layer should be made of a precious metal having a high melting point such as platinum, palladium, rhodium, molybdenum, or the like, a material whose main component comprises an alloy of silver and palladium, an alloy of silver and platinum, an alloy of platinum and palladium, or the like, or a cermet of platinum and a ceramics material. More preferably, the electrically conductive coating layer should be made of a material whose main component comprises platinum or a platinum-based alloy. The electrodes may also be made of carbon, a graphite material such as thin-film diamond, diamond-like carbon, carbon nanotube, for example. The ceramics material to be added to the electrode material should preferably be of a proportion ranging from 5 to 30 volume %.

The drive electrode 4 may be formed of any of the above materials according to any of ordinary film forming process, e.g., any of various thick-film forming processes such as screen printing, spraying, electrically conductive coating, dipping, coating, electrophoresis, etc., or any of various thin-film forming processes such as sputtering, ion beam, vacuum evaporation, ion plating, CVD, plating, etc. Preferably, the drive electrode 4 should be formed by any of the above thick-film forming processes.

If the drive electrode 4 is formed by a thick-film forming process, then the thickness of the drive electrode 4 is generally 20 μm or less, preferably 5 μm or less.

The common electrode 5 is made of the same material according to the same process as the drive electrode 4. Preferably, the common electrode 5 should be formed by any of the above thick-film forming processes. The thickness of the common electrode 5 is also generally 20 μm or less, preferably 5 μm or less.

Although certain preferred embodiments of the present invention have been shown and described in detail, it should be understood that various changes and modifications may be made therein without departing from the scope of the present invention.

What is claimed is:

1. A light emission device comprising:
an electric field receiving member made of a dielectric material;
a first electrode disposed on one surface of said electric field receiving member;
a second electrode disposed on said one surface of said electric field receiving member, said second electrode and said first electrode jointly defining a slit; and
a fluorescent layer disposed on said second electrode.

2. A light emission device according to claim 1, further comprising:
an insulating layer and a third electrode interposed between said second electrode and said fluorescent layer, said insulating layer being positioned adjacent to said second electrode.

3. A light emission device according to claim 1, wherein one of said first electrode and said second electrode is circular in shape, the other of said first electrode and said second electrode is annular in shape around said circular one of said first electrode and said second electrode, and the slit defined between said first electrode and said second electrode is annular in shape.

4. A light emission device according to claim 1, wherein at least one of said first electrode and said second electrode has at least one of a convexity and a concavity.

5. A light emission device according to claim 1, further comprising at least one of a pinhole defined in at least one of said first electrode and said second electrode, and a land disposed in said slit in electrically insulated relation to said first electrode and said second electrode and made of a material which is the same as the material of said first electrode and said second electrode.

6. A light emission device according to claim 1, wherein said electric field receiving member has a specific dielectric constant of 1000 or greater.

7. A light emission device according to claim 1, wherein said slit has a width in a range between 0.1 μm and 500 μm.

8. A light emission device according to claim 7, wherein said slit has a width in a range between 0.1 μm and 50 μm.

9. A light emission device according to claim 8, wherein said slit has a width in a range between 0.1 μm and 10 μm.

10. A light emission device according to claim 9, wherein said slit has a width in a range between 0.1 μm and 1 μm.

11. A light emission device according to claim 1, wherein said electric field receiving member is made of a pizoelectric material, an antiferroelectric material, or an electrostrictive material.

12. A light emission device comprising:
an electric field receiving member made of a dielectric material;
a first electrode disposed on one surface of said electric field receiving member;
a second electrode disposed on said one surface of said electric field receiving member, said second electrode and said first electrode jointly defining a slit;
an electrically conductive coating layer disposed on said first electrode, said second electrode, and said slit; and
a fluorescent layer disposed on said electrically conductive coating layer.

13. A light emission device according to claim 12, further comprising:
an insulating layer and a third electrode interposed between said electrically conductive coating layer and said fluorescent layer, said insulating layer being positioned adjacent to said electrically conductive coating layer.

14. A light emission device according to claim 12, wherein one of said first electrode and said second electrode is circular in shape, the other of said first electrode and said second electrode is annular in shape around said circular one of said first electrode and said second electrode, and the slit defined between said first electrode and said second electrode is annular in shape.

15. A light emission device according to claim 12, wherein at least one of said first electrode and said second electrode has at least one of a convexity and a concavity.

16. A light emission device according to claim 12, further comprising at least one of a pinhole defined in at least one of said first electrode and said second electrode, and a land disposed in said slit in electrically insulated relation to said first electrode and said second electrode and made of a material which is the same as the material of said first electrode and said second electrode.

17. A light emission device according to claim 12, wherein said electric field receiving member has a specific dielectric constant of 1000 or greater.

18. A light emission device according to claim 12, wherein said slit has a width in a range between 0.1 μm and 500 μm.

19. A light emission device according to claim 18, wherein said slit has a width in a range between 0.1 μm and 50 μm.

20. A light emission device according to claim 19, wherein said slit has a width in a range between 0.1 μm and 10 μm.

21. A light emission device according to claim 20, wherein said slit has a width in a range between 0.1 μm and 1 μm.

22. A light emission device according to claim 12, wherein said electric fielf receiving member is made of a pizoelectric material, an antiferroelectric material, or an electrostrictive material.

23. A field emission display comprising a two-dimensional array of light emission devices, each of said light emission devices comprising:
an electric field receiving member made of a dielectric material;
a first electrode disposed on one surface of said electric field receiving member;
a second electrode disposed on said one surface of said electric field receiving member, said second electrode and said first electrode jointly defining a slit; and
a fluorescent layer disposed on said second electrode.

24. A field emission display according to claim 23, further comprising:
an insulating layer and a third electrode interposed between said second electrode and said fluorescent layer, said insulating layer being positioned adjacent to said second electrode.

25. A field emission display according to claim 23, wherein one of said first electrode and said second electrode is circular in shape, the other of said first electrode and said second electrode is annular in shape around said circular one of said first electrode and said second electrode, and the slit defined between said first electrode and said second electrode is annular in shape.

26. A field emission display according to claim 23, wherein at least one of said first electrode and said second electrode has at least one of a convexity and a concavity.

27. A field emission display according to claim 23, further comprising at least one of a pinhole defined in at least one of said first electrode and said second electrode, and a land disposed in said slit in electrically insulated relation to said first electrode and said second electrode and made of a material which is the same as the material of said first electrode and said second electrode.

28. A field emission display according to claim 23, wherein said electric field receiving member has a specific dielectric constant of 1000 or greater.

29. A field emission display according to claim 23, wherein said slit has a width in a range between 0.1 μm and 500 μm.

30. A field emission display according to claim 29, wherein said slit has a width in a range between 0.1 μm and 50 μm.

31. A field emission display according to claim 30, wherein said slit has a width in a range between 0.1 μm and 10 μm.

32. A field emission display according to claim 31, wherein said slit has a width in a range between 0.1 μm and 1 μm.

33. A field emission display according to claim 23, wherein said electric fielf receiving member is made of a pizoelectric material, an antiferroelectric material, or an electrostrictive material.

34. A field emission display comprising a two-dimensional array of light emission devices, each of said light emission devices comprising:
an electric field receiving member made of a dielectric material;
a first electrode disposed on one surface of said electric field receiving member;
a second electrode disposed on said one surface of said electric field receiving member, said second electrode and said first electrode jointly defining a slit;
an electrically conductive coating layer disposed on said first electrode, said second electrode, and said slit; and
a fluorescent layer disposed on said electrically conductive coating layer.

35. A field emission display according to claim 34, further comprising:
an insulating layer and a third electrode interposed between said electrically conductive coating layer and said fluorescent layer, said insulating layer being positioned adjacent to said electrically conductive coating layer.

36. A field emission display according to claim 34, wherein one of said first electrode and said second electrode is circular in shape, the other of said first electrode and said second electrode is annular in shape around said circular one of said first electrode and said second electrode, and the slit defined between said first electrode and said second electrode is annular in shape.

37. A field emission display according to claim 34, wherein at least one of said first electrode and said second electrode has at least one of a convexity and a concavity.

38. A field emission display according to claim 34, further comprising at least one of a pinhole defined in at least one of said first electrode and said second electrode, and a land disposed in said slit in electrically insulated relation to said first electrode and said second electrode and made of a material which is the same as the material of said first electrode and said second electrode.

39. A field emission display according to claim 34, wherein said electric field receiving member has a specific dielectric constant of 1000 or greater.

40. A field emission display according to claim 34, wherein said slit has a width in a range between 0.1 μm and 500 μm.

41. A field emission display according to claim 40, wherein said slit has a width in a range between 0.1 μm and 50 μm.

42. A field emission display according to claim 41, wherein said slit has a width in a range between 0.1 μm and 10 μm.

43. A field emission display according to claim 42, wherein said slit has a width in a range between 0.1 μm and 1 μm.

44. A field emission display according to claim 34, wherein said electric fielf receiving member is made of a pizoelectric material, an antiferroelectric material, or an electrostrictive material.
